(19) United States
(12) Patent Application Publication
(10) Pub. No.: US 2015/0372919 A1
(43) Pub. Date: Dec. 24, 2015

(54) SYSTEMS AND METHODS FOR ENHANCED SIGNALING FOR BEACON LOAD REDUCTION

(71) Applicant: QUALCOMM Incorporated, San Diego, CA (US)

(72) Inventors: Yan Zhou, San Diego, CA (US); George Cherian, San Diego, CA (US); Simone Merlin, Solana Beach, CA (US)

(21) Appl. No.: 14/311,042

(22) Filed: Jun. 20, 2014

(51) Int. Cl. H04L 12/801

(52) U.S. Cl. CPC H04L 47/12; H04W 28/12

(57) ABSTRACT

In a dense network, a node (e.g., a station) may receive beacons from a large number of access points. This may result in the node receiving a large quantity of beacons, which may affect the node's ability to efficiently utilize the communication medium. Thus, in some embodiments, the node may be capable of detecting or determining a beacon load it sees from one or more access points and determine if its beacon load is equal to or above one of a total beacon load threshold or an individual access point beacon load threshold. The total beacon load threshold or the individual beacon load threshold may be determined by at least one of the node, the access points, the user, or the network, and the node may request each access point from which the node receives beacons to reduce its beacon load.

### BACKGROUND

1. Field of the Invention

The present application relates generally to wireless network communications, and more specifically to systems, methods, and devices for reducing a beacon load of a wireless device with respect to the beacon load received from one or more wireless access points.

2. Description of the Related Art

In many communication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

One or more devices in a wireless network may be configured to provide beacons to the other connected devices in the wireless network. These beacons may be used by the connected devices to maintain synchronization and communication necessary information to ensure consistent communication on the wireless network. Each devices connected to the wireless network will receive beacons associated with the wireless network. Additionally, devices connected to more than one wireless network may receive beacons associated with the more than one wireless network. Thus, a device connected to multiple wireless networks may receive a larger quantity or load of beacons than a device connected to a single wireless network. Accordingly, systems, methods, and devices for allowing a device to request an access point reduce its beacon load to be below a threshold value are desired.

### SUMMARY OF THE INVENTION

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description,” one will understand how the features of the various embodiments of this invention provide advantages that include improved capture of moments of action by a user with imaging equipment.

One aspect of the subject matter described in the disclosure provides an apparatus for detecting a beacon load and requesting the beacon load from at least one other device be reduced. The apparatus comprises a processing system configured to detect a beacon load of the apparatus and to generate a request to reduce a beacon load if the detected beacon load satisfies a criterion and an interface for outputting the request for transmission.

Another aspect of the subject matter described in the disclosure provides a method of communication by an apparatus, the method comprising processing a beacon load received from one or more devices, said processing including determining if the received beacon load from the one or more devices satisfies a criterion, generating a request to reduce the beacon load if the received beacon load does not satisfy the criterion, and outputting the request to reduce the beacon load for transmission to the one or more devices.

Yet another aspect of the subject matter described in the disclosure provides a wireless node for wireless communication, the wireless node comprising an antenna and a processing system. The processing system may be configured to process a beacon load of the wireless node, a beacon load comprising at least one beacon received via the antenna, determine if the beacon load satisfies a criterion, and generate a request to reduce a beacon load if the beacon load satisfies the criterion.

An additional aspect of the subject matter described in the disclosure provides a computer program product comprising a computer readable storage device encoded thereon with instructions that, when executed, cause an apparatus to perform a method of wireless communication, the method comprising receiving a beacon load from one or more devices, determining if the received beacon load from the one or more devices satisfies a criterion, generating a request to reduce the beacon load if the received beacon load does not satisfy the criterion, and transmitting the request to reduce the beacon load to the one or more devices.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Throughout the drawings, similar symbols typically identify similar components, unless context dictates otherwise. Note that the relative dimensions of the following figures may not be drawn to scale.

FIG. 1a illustrates one possible organization of a wireless network system with a single wireless network, a single access point, and multiple wireless access terminals.

FIG. 1b illustrates one possible organization of a wireless network system with multiple wireless networks, each comprising at least one access point, and multiple wireless access terminals dispersed between the multiple wireless networks.

FIG. 2 illustrates an embodiment of a wireless access terminal of one or more of the devices of FIGS. 1a and 1b.

FIG. 3 illustrates an embodiment of the structure of a message which may be used to communicate information between devices of FIGS. 1a and 1b.

FIG. 4a illustrates the communications exchanged between a wireless communication apparatus and an access point.

FIG. 4b illustrates the communications exchanged between the wireless communication apparatus and multiple access points.

FIG. 5 represents a flowchart of a method for requesting the reduction of a beacon load from an access point by a wireless access terminal.

FIG. 6 is a functional block diagram of a wireless communication apparatus that may be employed within the wireless communication systems of FIGS. 1 and 2.

### DETAILED DESCRIPTION OF CERTAIN INVENTIVE ASPECTS

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols. For example, the various aspects described herein may be used as part of the IEEE 802.11ah protocol, which uses sub-1 GHz bands.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be three types of devices: access points (“APs”), relays, and clients (also referred to as access terminals, stations, or “STAs”). In general, an AP serves as a hub or base station for the WLAN, a relay device provides a communication link between the AP for the WLAN and one or more STAs, which serve as users of the WLAN. For example, an STA may be a laptop computer, a personal digital assistant (PDA), a mobile phone, etc. In an example, an STA connects to an AP, through a relay device, via Wi-Fi (e.g., IEEE 802.11 protocol such as 802.11ah) compliant wireless links to obtain general connectivity to the Internet or to other wide area networks. In some implementations, an STA may also be used as a relay device. In some implementations an STA may also be used as an AP. A STA or an AP may be referred to as a node or a wireless node in a wireless communications network. A STA or an AP may be referred to as a wireless device or an access terminal in a wireless communications network.

Another aspect disclosed is a wireless node for wireless communication. The wireless node includes an antenna, a processing system configured to generate a message indicating a start time of a window during which one or more devices are permitted to communicate with the apparatus, the start time being based on an absolute time reference; and a transmitter configured to transmit the generated message using the antenna.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

A wireless device may comprise an access terminal (“AT”) or STA, an AP or a relay-capable wireless device having at least one of a STA or AP operation, i.e., a wireless device may have AT or STA operation, AP operation, or both AT/STA and AP operations.

As discussed above, certain of the devices described herein may implement the 802.11ah standard, for example. Such devices, whether used as an STA, a relay device, an AP, or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

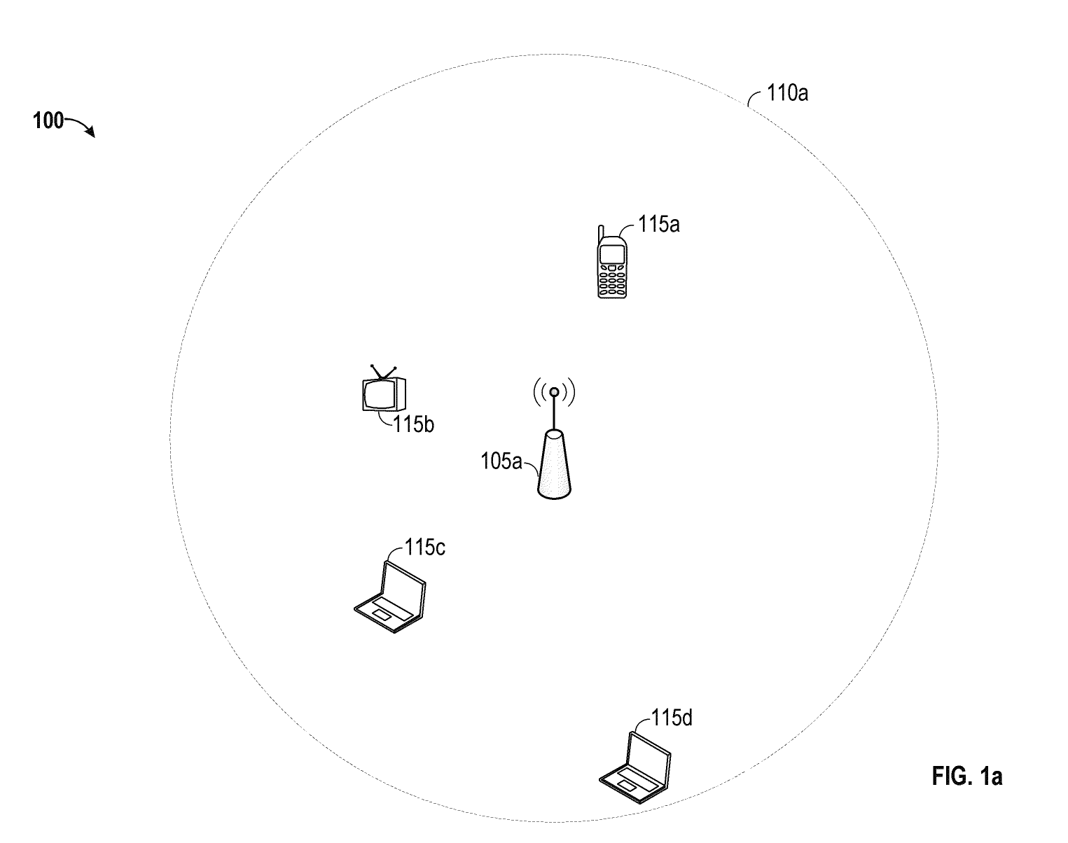

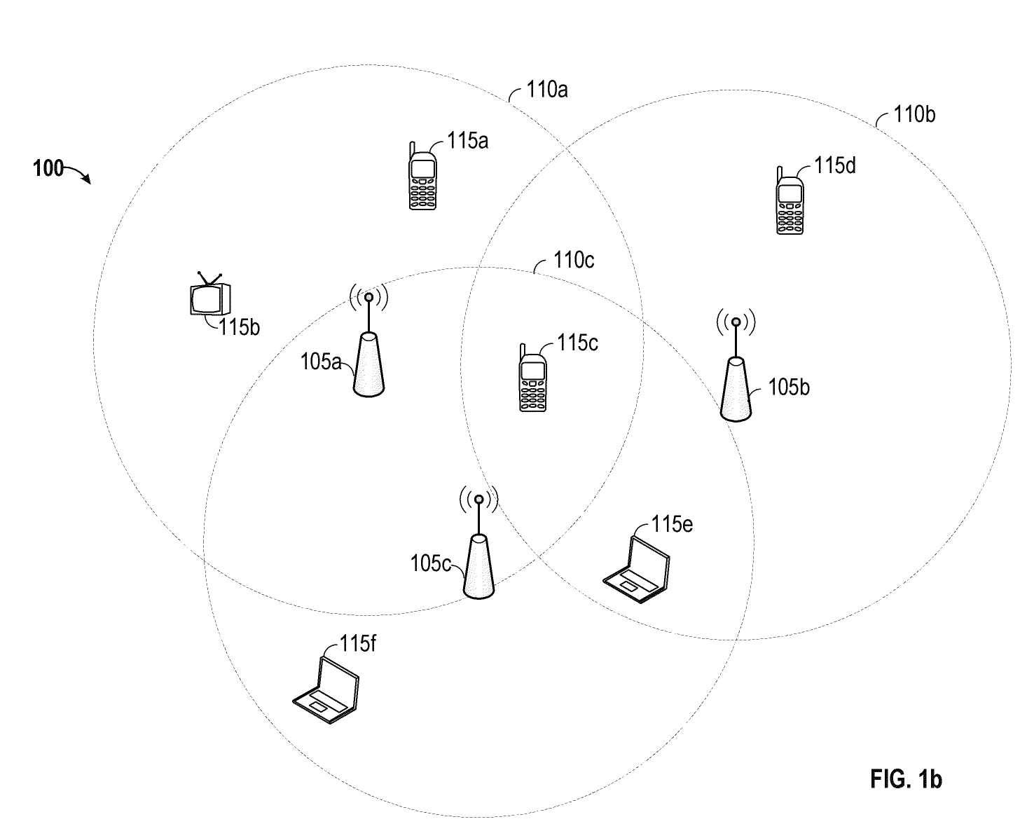

Referring to FIG. 1a, an illustrative embodiment of a wireless network system with a single wireless network, an access point, and a plurality of wireless devices is shown and generally designated 100. The access point 105a is depicted in the center of the wireless network 110a. Wireless network 110a generally depicts the range of the access point 105a. Wireless devices 115a-115d are depicted dispersed throughout wireless network 110a. Wireless access terminals 115a-115d may comprise any devices that may utilize a wireless network system 100.

As discussed above, wireless network 110a generally depicts the wireless range of access points 105a. This range may indicate the coverage area over which the access point 105a may communicate with wireless access terminals 115a-115d via the wireless network 110a. To communicate on the wireless networks 110a, the wireless access terminals 115a-115d may be associated with the wireless network 110a. An associated wireless access terminal 115a-115d may be considered a member of the wireless network 110a. The wireless access terminals 115a-115d that are members of the wireless network 110a may communicate with other wireless access terminals 115a-115d that are members of the wireless network 110a. A member of the wireless network 110a may actively or passively participate in communications on the wireless network 110a. These communications may be directed to other wireless access terminals 115a-115d or to the access point 105a. As members of the wireless network 110a, wireless access terminals 115a-115d may receive beacons from the access point 105a. These beacons (not shown in this figure) may communicate information between the access point 105a and the wireless access terminals 115a-115d to maintain proper connections and associations, for example timing synchronization information, indicators of information to be transmitted to a particular wireless access terminal 115a-115d, or parameters for the network connection between the wireless access terminal 115a-115d and the access point 105a-105b. In some embodiments, a wireless access terminal 115a-115d may receive beacons from all access points 105a-105b with which the wireless access terminal 115a-115d is associated.

Beacons between the access point 105a or 105b and the associated member wireless access terminals 115a-115d are communicated on the same channel as that used for the data communications between wireless access terminals 115a-115d and the access point 105a or 105b and other wireless access terminals 115a-115d. Accordingly, when receiving a beacon from an access point 105a, the wireless access terminals 115a-115d may be unable to utilize the network medium for other purposes, e.g., transmission or receipt of data or other information as may be required by other commitments the wireless access terminals 115a-115d may have. When the wireless access terminals 115a-115d only receive beacons from a single access point 105a or 105b, the wireless access terminal 115a-115d usage of the network medium may not be adversely affected by the beacon load. Here, in some embodiments, the beacon load of the wireless access terminal 115a-115d may be defined as the percentage or amount of time occupied by receiving and/or processing beacons. In some other embodiments, the beacon load of the wireless access terminal 115a-115d may be defined as the number of beacons received at the wireless access terminal 115a-115d However, in other embodiments where multiple access points 105a-105b are transmitting many beacons to the wireless access terminal 115a-115d, the beacon load may adversely impact the wireless access terminal 115a-115d ability to utilize the network medium for data or other communications. In some embodiments, the quantity of beacons received by a wireless access terminal 115a-115d from all associated access points 105a-105b or wireless networks 110a-110b may be referred to as the wireless access terminal total beacon load of the wireless access terminal 115a-115d. In other embodiments, the beacon load may refer to a metric indicative of a number of beacons a wireless access terminal 115a-115d may receive from an individual access point or on a single wireless network. In this embodiment, the beacon load may exist for every access point 105a-105b with which the wireless access terminal 115a-115d is associated. Accordingly, the wireless access terminal 115a-115d may have a total beacon load comprising the beacon loads of the wireless access terminal 115 from each associated access point 105a-105b.

Referring to FIG. 1b, an illustrative embodiment of a wireless network system with multiple wireless networks, each comprising an access point, and a plurality of wireless access terminals dispersed within the wireless networks is depicted and generally designated 100. Three wireless networks are shown and designated 110a-110c, each wireless network 110a-110c comprising a wireless access point 105a-105c, respectively. Wireless access terminals 115a-115f may be dispersed between the wireless networks 110. Accordingly, some of the wireless access terminals 115a-115f may be within more than one wireless network 110.

The access points 105a-105c may manage the communications of their respective wireless networks 110a-110c. The functions of the access points 105a-105c may be similar to those as discussed in reference to the access point 105a of FIG. 1a.

The wireless access terminals 115a-115f that are within multiple wireless networks 110a-110c of the wireless networks 110a-110c may receive beacons from each of the access points 105a-105c with which the wireless access terminal 115a-115f may communicate via wireless networks 110a-110c. For example, wireless access terminal 115e may receive beacons from both access point 105b and access point 105c, because wireless access terminal 115e is a member of both wireless networks 110b and 110c. Similarly, wireless access terminal 115c is a member of wireless networks 110a, 110b, and 110c, and may receive beacons from each of access point 105a, 105b, and 105c. Wireless access terminals 115a, 115b, and 115d may be members of only a single wireless network 110a-110c and may receive beacons from only the single access point 105a-105c with which they are associated.

The increased beacon load for the wireless access terminals 115c and 115e in comparison to the beacon loads for the wireless access terminals 115a, 115b, 115d, and 115f may result in a reduced ability to utilize the network medium for wireless access terminals 115c and 115e. Accordingly, wireless access terminals 115c and 115e may utilize a method to request that access points 105a-105c with which the wireless access terminals 115a-115f are associated reduce their respective beacon loads if the respective beacon loads are above a threshold value. The determination of whether to utilize the method to request an access point 105a-105c reduce its beacon load may involve comparing a beacon load to a threshold limit. In some embodiments, the threshold limit may represent the upper limit of the beacon load, either in number of beacons received/transmitted or amount of time consumed by the beaconing processes, or in some other appropriate measure. If the beacon load of the wireless access terminal 115a-115f is equal to or greater than the threshold limit, the wireless access terminal 115a-115f may request a beacon load reduction. For example, if the threshold limit for a wireless access terminal 115c is a maximum of five beacons per second, when the wireless access terminal 115c has a beacon load of five beacons per second or higher, the wireless access terminal 115c may request a beacon load reduction of at least one of the access points 105a, 105b, or 105c with which the wireless access terminal 115c is associated. Similarly, if the threshold limit for wireless access terminal 115c is a maximum of 5 milliseconds (ms) of beaconing per minute of data transfer, when the beaconing time is equal to or greater than 5 ms, the wireless access terminal 115c may request a beacon load reduction. In some embodiments, the beacon load discussed above may represent the total beacon load on the wireless access terminal 115a-115f If the total beacon load is above the threshold limit, then the wireless access terminal 115a-115f may request any or all of the of the associated access points 105a-105c contributing to the total beacon load to reduce their beacon loads. In some other embodiments, the beacon load discussed above may represent the beacon load on the wireless access terminal 115a-115f from a specific access point 105a-105c. In such an embodiment, the wireless access terminal 115a-115f may request the specific access point 105a-105c to reduce its beacon load.

In some embodiments, when the total beacon load exceeds the threshold limit, the wireless access terminal 115a-115f may request a beacon load reduction from a subset of the access points 105a-105c with which the wireless access terminals 115a-115f is associated. For example, when the beacon load exceeds the threshold limit, wireless access terminal 115c may request that access point 105a reduce its beacon load to wireless access terminal 115c while allowing access points 105b and 105c to maintain their current beacon loads. In some other embodiments, the beacon load reduction request may be the same for all associated access points 105, in that each of wireless access points 105a, 105b, and 105c associated with the wireless access terminal 115a-115f may be requested to reduce their beacon loads. In some embodiments, such access points 105a, 105b, and 105c may each be asked to reduce the beacon loads by the same number or percentage of beacons or time of beaconing for each access point 105a-105c, while other embodiments may request all associated access point 105a-105c to reduce their beacon loads, but may allow the beacon load reduction amounts to vary for each access point 105a-105c.

In some embodiments, the wireless access terminal 115a-115f may compare a beacon load from each of the associated access points 105a-105c to a threshold to detect or determine if the beacon load associated with any individual access points 105a-105c is equal to or greater than the threshold limit. In such an instance, the wireless access terminal 115a-115f may request the access point 105a-105c with the beacon load that exceeds the threshold to reduce its beacon load. In some other embodiments, if the total beacon load (the combination of all beacon loads from all access points 105a-105c) is equal to or greater than the total threshold limit, then the wireless access terminal 115a-115f may detect or determine how much the total beacon load needs to be reduced such that the total beacon load after reduction is below the threshold limit, and request beacon load reductions accordingly.

If the beacon load is equal to or greater than the threshold limit, then the wireless access terminal 115a-115f may automatically request the beacon load reduction according to a pre-determined, incremental process, and may continue to make further beacon load reduction requests until the beacon load satisfies the threshold limit. For example, if the wireless access terminal 115e compares the beacon load from access point 105b to the threshold limit and detects or determines that the beacon load exceeds the threshold, then the process may instruct that the wireless access terminal 115e request a beacon load reduction of one beacon message or 1 ms (dependent upon the method of measuring beacon load). Subsequently, if the beacon load continues to exceed the threshold, the process may then increment the reduction request to three beacon messages or 3 ms. Accordingly, the process may continue to increase the reduction amount in the beacon load reduction requests until the beacon load is reduced below the threshold limit. In other embodiments, the process may maintain a fixed beacon load reduction request as opposed to incremental reduction requests, so that the reduction amount is always a fixed and constant amount. In even other embodiments, the process may be dynamically adjustable by the wireless access terminal 115a-115f dependent upon the comparison of the beacon load and the threshold limit, such that the reduction amount in the beacon load reduction request will reduce the beacon load below the threshold amount after a single request. In other embodiments, the process may select a reduction amount arbitrarily. In another embodiment, the reduction amount may be user selectable. After reducing the beacon load or the total beacon load below the respective thresholds, the wireless access terminal 115a-115f may not submit beacon load reduction requests until the threshold limit is again exceeded.

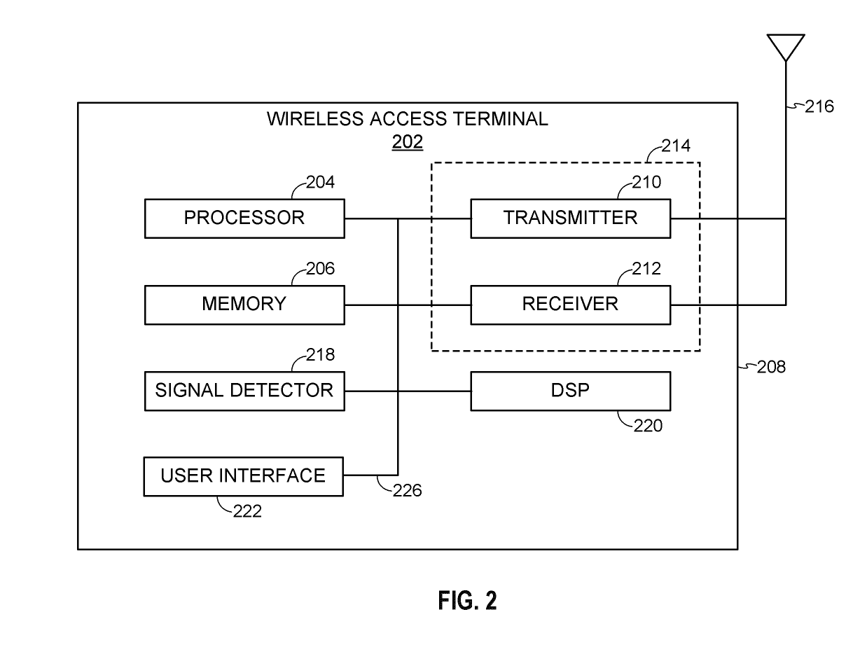

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the access point 105a, or one of wireless access terminals 115a-115f, for example.

The wireless device 202 may include a processor 204 which controls operation of the wireless device 202. The processor 204 may also be referred to as a central processing unit (CPU), a hardware processor, or a processing system. Memory 206, which may include both read-only memory (ROM) and random access memory (RAM), provides instructions and data to the processor 204. A portion of the memory 206 may also include non-volatile random access memory (NVRAM). The processor 204 performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory computer-readable medium comprising code that, when executed, causes an apparatus to perform one or more steps associated with one or more methods for modifying relay operation of a relay-compatible wireless device. Code may include source code format, binary code format, executable code format, or any other suitable format of code. The code, or instructions, when executed by one or more processors, causes the processing system to perform the various functions described herein.

The wireless device 202 may also include a transmitter 210 and a receiver 212 to allow transmission and reception of data between the wireless device 202 and a remote location. Further, the transmitters 210 and the receiver 212 may be configured to allow transmission and reception of setup and/or configuration packets or frames between the wireless device 202 and a remote location including, for example, an AP, a relay device, or an STA. The transmitter 210 and receiver 212 may be combined into a transceiver 214. An antenna 216 may be attached to the housing 208 and electrically coupled to the transceiver 214. Alternatively, or additionally, the wireless device 202 may include an antenna 216 formed as part of the housing 208 or may be an internal antenna. The wireless device 202 may also include (not shown) multiple transmitters, multiple receivers, multiple transceivers, and/or multiple antennas. Transmitter 210 or transceiver 214 may be utilized as an interface for outputting a request for transmission to the access points 105.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet or a frame.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be housed within a housing 208. Further, the various components of the wireless device 202 may be coupled together by a bus system 226 (or bus interface). The bus system 226 may include a data bus, for example, as well as a power bus, a control signal bus, and a status signal bus in addition to the data bus. Each of the components of the wireless device 202 may be connected to the bus system 226. The bus system 226 or bus interface may link the wireless device 226 to various other devices or circuits, such as time sources, peripherals, voltage regulators, power management circuits, and the like, which are well known in the art. Those of skill in the art will also appreciate the components of the wireless device 202 may be coupled together, or may accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

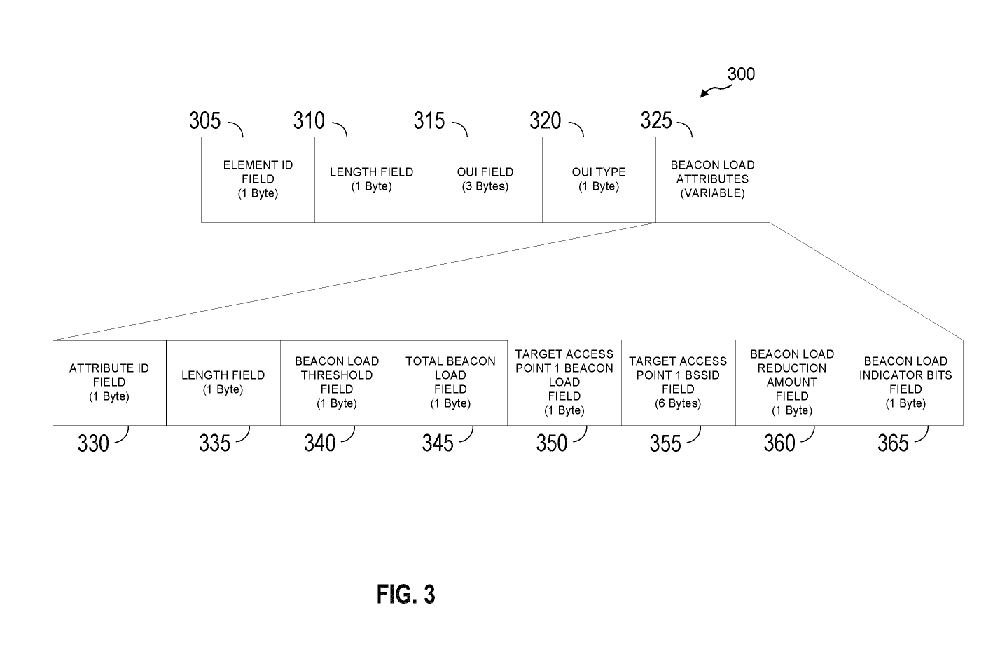

FIG. 3 illustrates an embodiment of the structure of a message which may be used to communicate beacon load information between devices of FIGS. 1a and 1b, specifically the access points 105a-105c and the wireless access terminals 115a-115f FIG. 3 shows an embodiment of a beacon load information element (IE) 300 for communicating beacon load attributes of a wireless access terminal 115a-115f to another wireless access terminal 115a-115f or access point 105a-105c. Those skilled in the art will appreciate that the beacon load IE 300 may have more or fewer components than illustrated in FIG. 3. As shown, the beacon load IE 300 includes a sampling of elements useful for describing some prominent features of implementations within the scope of the claims and may include one or more additional fields that are not shown or may include one or more fields that may not be utilized in all embodiments. The beacon load IE 300 includes an element ID field 305, which may be 1 byte in length, for example, and may include an integer value identifying the specific beacon load IE 300. The beacon load IE 300 may further include a length field 310, which may also be 1 byte in length, and which may include an integer value indicating the length, in octets, of the following fields in the beacon load IE 300. The value of the beacon load IE 300 length field as depicted, for example, may be 4 plus the total length of the beacon load attributes. The beacon load IE 300 may further include an organizationally unique identifier (OUI) field 315, which may be 3 bytes in length, and may include an integer value representing a Wi-Fi Alliance (WFA) or vendor specific OUI. The beacon load IE 300 may further include an OUI type field 320, which may be 1 byte in length, and may include a value identifying the type and/or version of the beacon load IE 300. The beacon load IE 300 may further include a beacon load attributes field 325, which may be of variable length and may contain beacon load attributes therein.

As shown in FIG. 3, beacon load attributes field 325, which may be contained within beacon load IE 300, may include a beacon load attribute ID field 330, which may be 1 byte in length, which may contain a value of “1” indicating the type of beacon load attribute being a beacon load threshold attribute. The beacon load attribute field 325 may also include a length field 335 of 1 byte, which may include an integer value indicating the length of the fields following in the attribute. The beacon load attribute field 325 may include a beacon load threshold field 340 of 1 byte which may indicate the maximum beacon load allowed for a wireless access terminal, either from an individual access point or the total combined for all access points 105a-105c. The distinction between an individual threshold or a total threshold may be indicated by an indicator bit in the beacon load indicator bits field 360. The beacon load attribute field 325 may also include a total beacon load field 345 of length 1 byte which may include the total current beacon load of the wireless access terminal 115. The beacon load attribute field 325 may also include a target access point 1 beacon load field 350 of a 1 byte length representing the beacon load of an individual access point, which may be the access point 105a-105c. The beacon load attribute field 325 may also include a target access point BSSID field 355 of a 6 byte length representing the basic service set identification (BSSID) of the target access point. The beacon load attribute field 325 may also include a beacon load reduction amount field 360 of 1 byte, which may include an integer value indicating an amount the wireless access terminal 115a-115f is requesting the target access point 105a-105c to reduce its beacon load. As discussed above, in some embodiments, this value may represent the number of beacons or time, among others, by which the wireless access terminal 115a-115f is requesting the beacon load be reduced.

The beacon load attribute field 325 may also include a beacon load indicator bits field 365, comprising individual bits each intended to indicate specific parameters or elements of the beacon load reduction request. For example a beacon load reduction request bit, set to “1,” may indicate that the beacon load IE 300 is intended to communicate a request to reduce a beacon load from an access point 105a-105 or a wireless access terminal 115a-115f Additionally, a beacon load reduction acceptance bit may be set to “1” to indicate that the target device has accepted the requested beacon load reduction amount. An additional beacon load total bit may be set to “1” to indicate that the beacon load threshold in the beacon load threshold field 340 is intended to be a total beacon load threshold of the combination of all the beacon loads from the associated access points. The remaining 5 bits of the byte may be reserved for future use. Additional fields (not shown), including but not limited to requesting device location, may be included in the beacon load attribute field of beacon load attributes 325. Additionally, the structure of the beacon load attributes of the beacon load attributes field 325 may be formatted such that the most important fields for beacon load reduction is located in a specific location in the attribute. In some other embodiments, the beacon load IE 300 may further comprise fields for detected beacon load, a beacon load per basic service set identification, and a suggested beacon load reduction criterion for transmission to at least one device. The suggested beacon load reduction criterion for transmission may comprise an amount that the beacon load is suggested to be reduced, for example to be below the beacon load threshold.

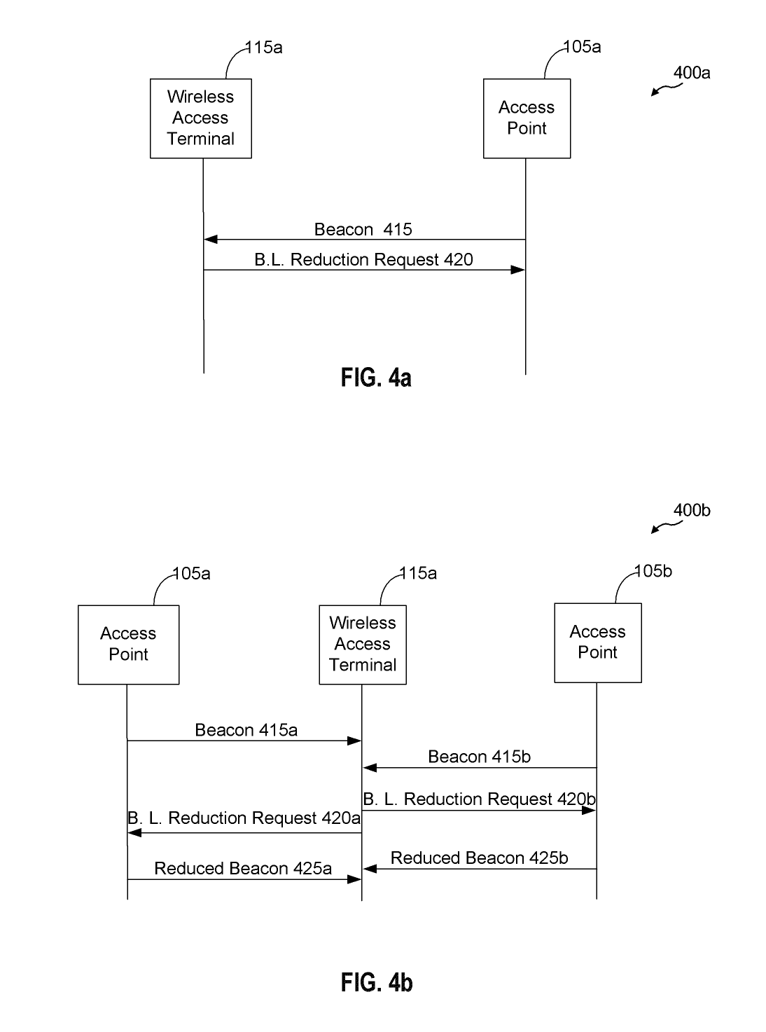

FIG. 4a illustrates the communications exchanged between a wireless communication apparatus and an access point. FIG. 4a is a call flow diagram of a method for requesting a beacon load reduction between a wireless access terminal 115a-115f (corresponding to a wireless communication apparatus or a wireless access terminal 115a) and an access point 105a, in accordance with one implementation, and generally designated 400a. In one embodiment, the beacon load reduction request may begin with the determination or receipt (not shown) of the beacon load threshold for the wireless access terminal 115a. In some embodiments, the beacon load threshold may be determined by the manufacturer of the wireless access terminal 115a. In other embodiments, the beacon load threshold may be determined by a third party wireless access terminal 115b-115f In some other embodiments, the beacon load threshold may be determined by the access points 105a with which the wireless access terminal 115a is communicating, or by the wireless access terminal 115a itself. In such an embodiment, the access point 105a-105c may generate and transmit (not shown in this figure) a message (i.e., beacon load IE 300 from FIG. 3) containing the beacon load threshold for wireless access terminal 115a. Thereafter, the wireless access terminal 115a may detect or determine its beacon load and compare its beacon load to the beacon load threshold. If the beacon load of the wireless access terminal 115a is below the beacon load threshold, then the wireless access terminal 115a does not request a beacon load reduction of any access point 105a. If the beacon load of the wireless access terminal 115a is equal to or greater than the beacon load threshold, then the wireless access terminal 115a may generate a request for beacon load reduction of at least one of the access points 105a with which the wireless access terminal 115a is communicating. In some embodiments, the wireless access terminal 115a may be communicating with only one access point 105a and may request that access point 105a reduce its beacon load on the wireless access terminal 115a. In some other embodiments, the node 405 may be communicating with more than one access point 105a, and the wireless access terminal 115a may request that one or more of the access points 105a reduce their beacon loads.

The wireless access terminal 115a may receive one or more beacons 415 from an access point 105a. Upon determining that the beacon load is equal to or exceeds the beacon load threshold, the wireless access terminal 115a may generate a beacon load reduction request 420. In some embodiments, generating the beacon load reduction request 420 may comprise determining how much the beacon load of the wireless access terminal 115a must be reduced to be below the beacon load threshold and requesting the target access point(s) 105a to reduce their beacon loads accordingly. In some other embodiments, generating the request may comprise utilizing the process discussed above to detect or determine the request amount to include in the beacon load reduction request 420. The beacon load reduction request 420 may request the access point 105a reduce the beacon transmission frequency and/or the beacon transmission size. The beacon transmission size (beacon size) may comprise the length of the beacon or the amount of information included within a beacon or time required to process a beacon received from an access point 105. In some embodiments the beacon load reduction request 420 may comprise a quantity of beacons by which an access point 105a is requested to reduce its beacon load. This quantity may be determined by subtracting the beacon load threshold from the current beacon load, and determining that the quantity to reduce the beacon load must be greater than this subtracted value to ensure the resulting beacon load is below the beacon load threshold. In some embodiments, the quantity may be determined via other mathematical equations or methods. The beacon load reduction request 420 may be processed for transmission to the access point 105a from the wireless access terminal 115a via an interface for outputting the request for transmission. The interface may represent any manner of preparing data or information for communication or actively communicating data or information from the wireless access terminal 115a to the access point 105a. In some embodiments, the transmission may be output via an antenna and/or a transmission circuit or a transceiver.

In some alternate embodiments, the amount a beacon load is requested to be reduced may be based on a calculation by the wireless access terminal 115a of how much each target access point 105a must reduce its beacon load such that the total beacon load of the wireless access terminal 115a is below the beacon load threshold. The beacon load reduction request may be based on at least one of a new beacon transmission frequency or a new beacon transmission size that would reduce the detected beacon load of the wireless access terminal 115a to be equal to or below the total beacon load threshold or the individual access point 105a beacon load threshold.

In some embodiments, the wireless access terminal 115a may request each access point 105a reduce its beacon load by the same amount, e.g., 50%. In some other embodiments, the wireless access terminal 115a may request individual access points 105a reduce their beacon loads by individual amounts, e.g., access point 105a reduce beacon load by 50% while access point 105b reduce beacon load by 10%. In some embodiments, the individualized reduction requests may be based upon the beacon load contributed by the target access point 105a in relation to the total beacon load of the wireless access terminal 115a or in relation to specific access points 105a beacon load thresholds. In another embodiment, the beacon load reduction request may request a reduction by an amount as determined by the quantity by which the total beacon load exceeds the beacon load threshold.

FIG. 4b illustrates the communications exchanged between a wireless communication apparatus and multiple access points. FIG. 4b is a call flow diagram of a method for requesting a beacon load reduction between a wireless access terminal 115a-115f (corresponding to a wireless communication apparatus, or wireless access terminal 115a) and two access points 105a and 105b, in accordance with one implementation, and generally designated 400b. In one embodiment, the beacon load reduction request may begin with the determination or receipt (not shown) of the beacon load threshold for the wireless access terminal 115a, as discussed above. Then, as shown in FIG. 4b, the wireless access terminal 115a may receive one or more beacon loads 415a and 415b from the access points 105a and 105b. In the call flow diagram shown, one or both of the beacon loads 415a and 415b may individually exceed or cause the total beacon load of the wireless access terminal 115a to exceed the beacon load threshold. Accordingly, the wireless access terminal 115a detects or determines the amount to request one of or both access points 105a and 105b to reduce their beacon loads, and generates a beacon load reduction request 420 to send to the target access point 105a or 105b that is being requested to reduce its beacon load. That beacon load reduction request is then shown being sent from the wireless access terminal 115a to the access points 105a and 105b. In response, the access points 105a-105b are shown sending reduced beacon loads 425a and 425b to the wireless access terminal 115a after having received the beacon load reduction requests 420a.

As discussed above, the beacon load reduction request 420 may be in the form of the beacon load IE 300. In some embodiments, the access points 105a and 105b may generate and transmit a response (not shown in this figure) to the beacon load reduction request 420. This response may indicate whether or not the access point agrees to reduce its beacon load as requested by the wireless access terminal 115a. In some embodiments, one of the reserved bits in the beacon load indicator bits 360 may be used to indicate acceptance or rejection of the reduction request. If the access point 105a-105b disagrees with the reduction request, the access point may suggest a reduction amount that it would agree to, and send that information to the wireless access terminal 115a in beacon load IE 300. This may be due to a determination by the access point 105a-105b that it cannot reduce its load due to priority concerns, other commitments, etc. Then, the wireless access terminal 115a may have the option to agree to the updated reduction or to suggest new reduction parameters.

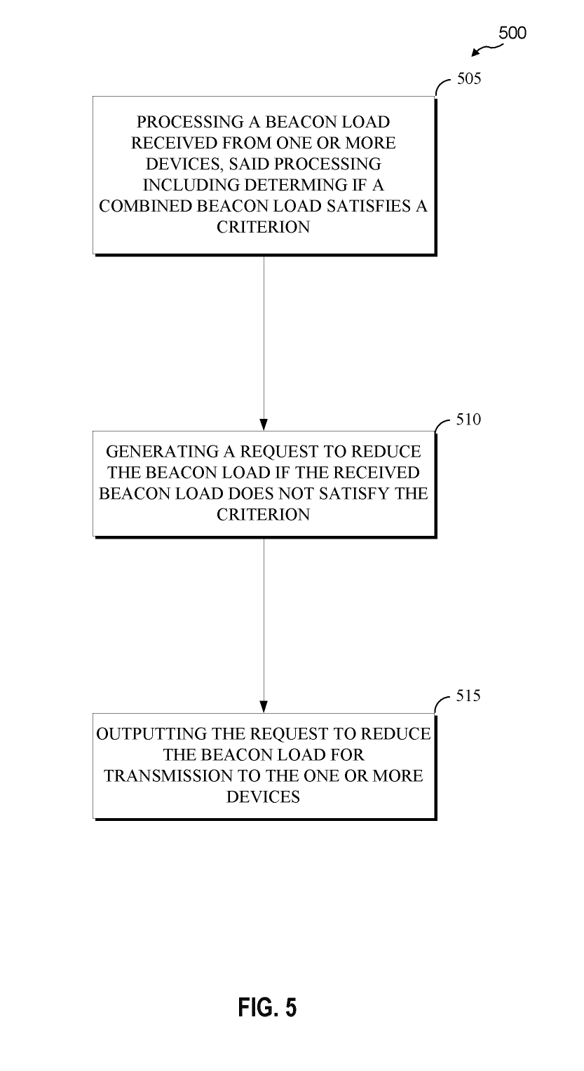

FIG. 5 refers to a flowchart of a method 500 for reducing a beacon load by a wireless access terminal from an access point. In an embodiment, a wireless access terminal, for example wireless access terminal 115a, may perform the method 500. In block 505, the wireless access terminal 115a may process a received beacon load, received from one or more access points 105a. The combined total number of the beacons received from the access point 105a and the amount of time necessary to receive and process the beacons may comprise the beacon load of the device. Additionally, the beacon may comprise all of the beacons the wireless access terminal 115a may receive from a particular access point 105a. In some embodiments, as discussed above, a beacon load may be received from more than one access point 105a. In such embodiments, the beacon loads received from each access point 105a may be of different sizes and require different amounts of time to receive and process. processing the received beacon load may comprise detecting or determining if a combined beacon load of the wireless access terminal 115a is below (i.e., satisfies) a criterion. In some embodiments, the criterion may comprise the beacon load threshold from a single access point or the total beacon load threshold from all access points. In some embodiments, as discussed above, the wireless access terminal 115a may receive the criterion from an access point 105a or other wireless access terminal 115a on the network. In some other embodiments, the criterion may be established by the wireless access terminal 115a manufacturer. In some embodiments, the wireless access terminal 115a may determine its own threshold. This threshold may be based upon other commitments or prioritization of beacon loads from other access points 105a as determined by the wireless access terminal 115a. In other embodiments, the criterion may be received from a managing server. In even other embodiments, the criterion may be established by the access point 105a and communicated to the wireless access terminal 115a. In some embodiments, if the criterion is communicated to the wireless access terminal 115a from another wireless access terminal 115a or access point 105a, the criterion may be communicated using the beacon load IE 300. In some other embodiments, the criterion may be communicated via any IE structure.

In some embodiments, the wireless access terminal 115a may detect or determine if the beacon load from an individual access point 105a is equal to or greater than the beacon load threshold. In some alternate embodiments, the wireless access terminal 115a may detect or determine if the total beacon load from all access points 105a is equal to or greater than the total beacon load threshold. The selection between applying the beacon load threshold to the total beacon load of all access points 105a of the wireless access terminal 115a or to the beacon load of only an individual access point 105a of the wireless access terminal 115a may be based upon the value of the beacon load total threshold bit of the beacon load indicator bits 360 discussed above. Alternatively, the selection between applying the beacon load threshold may be made by the wireless access terminal 115a.

At block 510, the wireless access terminal 115a may generate a request to reduce the beacon load of a target access point 105a if the beacon load does not satisfy the criterion of either the beacon load threshold for a single access point or the total beacon load threshold. For example, generating the request to reduce the beacon load from the target access point 105a may comprise determining the amount of beacon load to reduce and generating a formatted reduction request that the recipient access point 105a may understand. As discussed above, the reduction amount may be determined by at least one of a process, a preset reduction amount (i.e., established by the manufacturer, or communication standard), a third-party device, the wireless access terminal, a user, an access point, or a managing server. Additionally, the generated request to reduce the beacon load may conform to a beacon load IE 300 as discussed above.

At block 515, the wireless access terminal 115a may output the beacon load reduction request for transmission to one or more target device. In some embodiments, the target device may comprise an access point 105a whose beacon load is above a threshold for individual access points 105a. In another embodiment, the target device may comprise all access points 105a with which the wireless access terminal 115a communicates if the total beacon load of the wireless access terminal 115a exceeds the total beacon load threshold or if each of the access points 105 have individual beacon loads that are above the beacon load threshold. The total beacon load threshold may comprise the maximum threshold above which the wireless access terminal 115a may not have a combined beacon load from all sources. If the wireless access terminal 115a does have a total beacon load above the total beacon load threshold, the beacon loads from one or more access points 105 to the wireless access terminal 115a may be reduced. If the beacon load reduction request is sent to multiple target devices, the corresponding receive address could be a broadcast address, and the beacon load IE in FIG. 3 should include fields for every target device.

In some embodiments, when the wireless access terminal 115 may request more than one access point 105 to reduce their respective beacon load, the quantity of beacon load to be reduced, or the suggested beacon load reduction may be different for each of the different access points 105. Accordingly, the suggested beacon load reduction for a first device (e.g., access point 105a) may be less than or greater than (or equal to) the suggested beacon load reduction for a second device (e.g., access point 105b). The quantity of beacon load may represent the number of beacons, the amount of time, or the size of beacon that the wireless access terminal 115 requests an access point 105 reduce their beacon load. In some embodiments, the wireless access terminal 115a may process a communication received from at least a second device. This processing of the communication from at least the second device may comprise identifying a criterion that may represent the total beacon load threshold or the beacon load threshold for the wireless access terminal 115a, the values above which the wireless access terminal 115a may request associated access points 105 to reduce their respective beacon loads.

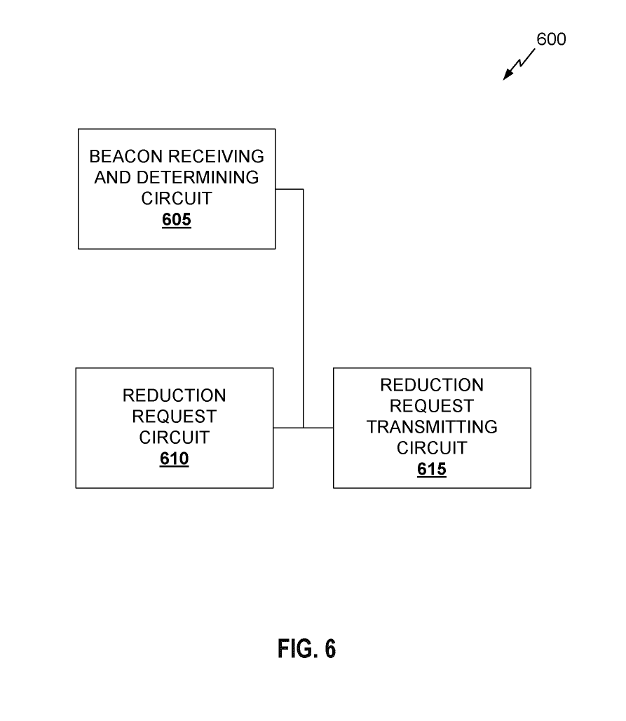

FIG. 6 is a functional block diagram of a wireless communication apparatus that may be employed within the wireless communication systems of FIGS. 1 and 2. Those skilled in the art will appreciate that a wireless communication apparatus may have more components than the simplified wireless communication apparatus 600 shown in FIG. 6. The wireless communication apparatus 600 shown includes only those components useful for describing some prominent features of implementations within the scope of the claims. The wireless communication apparatus 600 may include a beacon receiving and determining circuit 605, a beacon load reduction request circuit 610, and a reduction request transmission circuit 615.

In some aspects, one or more of the beacon receiving and determining circuit 605, the beacon load reduction request circuit 610, and/or the reduction request transmission circuit 615 may be implemented within one or more of the wireless access terminal 115a-115f discussed above.

In some implementations, the beacon receiving and determining circuit 605 may be configured to perform one or more of the functions discussed above with respect to block 505. The beacon receiving and determining circuit 605 may include one or more of a programmable chip, a processor, a memory, a receiver and a network interface. For example, the beacon receiving and determining circuit 605 may include the processor 204 and the receiver 212, or a transceiver 214. In some implementations, a means for receiving a beacon and determining whether a beacon load exceeds a threshold and/or a means for receiving a beacon load and determining a threshold may include the beacon receiving and determining circuit 605.

In some implementations, the beacon load reduction request circuit 610 may be configured to perform one or more functions discussed above with respect to block 510. The beacon load reduction request circuit 610 may include one or more of a programmable chip, a processor, a memory, a user interface, and a network interface. For example, the beacon load reduction request circuit 610 may include the processor 204, the memory 206, and/or the user interface 222. In some implementations, a means for generating a beacon load reduction request and a means for requesting an access point 105 to ‘reduce its beacon load may include the beacon load reduction request circuit 610.

In some implementations, the reduction request transmission circuit 615 may be configured to perform one or more of the functions discussed above with respect to block 515. The reduction request transmission circuit 615 may include one or more of a programmable chip, a processor, a memory, a user interface, a transmitter, and a network interface. For example, the reduction request transmission circuit 615 may include the processor 204, the user interface 222, the transceiver 214, and/or the transmitter 210. In some implementations, a means for transmitting a beacon load reduction message, and/or a means for transmitting a message based on a beacon load may include the reduction request transmission circuit 615.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), processing information received, and the like. Also, “determining” may include resolving, selecting, choosing, establishing and the like. Further, a “channel width” as used herein may encompass or may also be referred to as a bandwidth in certain aspects.

As used herein, the term interface may refer to hardware or software configured to connect two or more devices together. For example, an interface may comprise circuitry. The interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in hardware, an example hardware configuration may comprise a device similar to that described in FIG. 2. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. An apparatus for communicating, comprising:
a processing system configured to detect a beacon load of the apparatus and to generate a request to reduce a beacon load if the detected beacon load satisfies a criterion; and
an interface for outputting the request for transmission.

2. The apparatus of claim 1, wherein the processing system is further configured to process a communication received from at least one device, identify the criterion from the communication, the criterion comprising at least a total beacon load threshold for the apparatus, and determine whether the beacon load is equal to or greater than the total beacon load threshold.

3. The apparatus of claim 1, wherein the processing system is further configured to generate the request to reduce the beacon load to comprise at least one of a request to reduce a beacon transmission frequency or a request to reduce a beacon size.

4. The apparatus of claim 2, wherein the processing system is further configured to determine a quantity of the beacon load to be reduced so the beacon load is not equal to or does not exceed the total beacon load threshold.

5. The apparatus of claim 4, wherein the determination of the quantity of the beacon load to be reduced comprises subtracting a value greater than the total beacon load threshold from the beacon load.

6. The apparatus of claim 1, wherein the processing system is further configured to determine a portion of the beacon load attributed to at least one device and generate the request to reduce the beacon load for transmission to the at least one device.

7. The apparatus of claim 2, wherein the processing system is further configured to determine a quantity of the beacon load to be reduced by the at least one device and generate the request to reduce the beacon load to include the quantity of the beacon load to be reduced by the at least one device for transmission to the at least one device.

8. The apparatus of claim 2, wherein the processing system is further configured to determine at least one of a new beacon transmission frequency or a new beacon transmission size for the at least one device that would reduce the beacon load of the apparatus to be equal to or below the total beacon load threshold.

9. The apparatus of claim 2, wherein the processing system is further configured to compute a suggested beacon load to reduce for the at least one device such that the beacon load does not exceed the total beacon load threshold, wherein the suggested beacon load to reduce for a first of the at least one device is different from the suggested beacon load to reduce for a second of the at least one device.

10. The apparatus of claim 1, wherein the generated request to reduce the beacon load comprises at least one of the detected beacon load, a beacon load per basic service set identification, or a suggested beacon load reduction criterion for transmission to at least one device.

11. A method of communication by an apparatus, comprising:
processing a beacon load received from one or more devices, said processing including determining if the received beacon load from the one or more devices satisfies a criterion;
generating a request to reduce the beacon load if the received beacon load does not satisfy the criterion; and
outputting the request to reduce the beacon load for transmission to the one or more devices.

12. The method of claim 11, further comprising:
processing a communication received from at least a second device; and
identifying the criterion from the communication received from at least the second device, the criterion comprising at least a total beacon load threshold for the apparatus, wherein determining if the received beacon load from the one or more devices satisfies a criterion comprises determining whether the beacon load from the one or more devices is equal to or greater than the total beacon load threshold.

13. The method of claim 11, wherein generating the request to reduce the beacon load comprises generating the request to reduce at least one of a beacon transmission frequency or a beacon size.

14. The method of claim 12, further comprising determining a quantity of the beacon load to be reduced so that the beacon load is not equal to or does not exceed the total beacon load threshold.

15. The method of claim 14, wherein determining of the quantity of the beacon load to be reduced comprises subtracting a value greater than the total beacon load threshold from the beacon load.

16. The method of claim 11, further comprising determining a portion of the beacon load attributed to each of the one or more devices and transmitting the request to reduce to the beacon load to each of the one or more devices to which the portion of the beacon load is attributed.

17. The method of claim 12, further comprising determining a quantity of the beacon load to be reduced by the one or more devices, wherein generating the request to reduce the beacon load comprises generating a request to reduce the beacon load to include the quantity of the beacon load to be reduced by the one or more devices.

18. The method of claim 12, further comprising determining at least one of a new beacon transmission frequency or a new beacon transmission size for the one or more devices that would reduce the detected beacon load of the apparatus to be equal to or below the total beacon load threshold.

19. The method of claim 12, further comprising computing a suggested beacon load to reduce for the one or more devices such that the beacon load does not exceed the total beacon load threshold, wherein the suggested beacon load to reduce for a first device of the one or more devices is different from the suggested beacon load to reduce for a second device of the one or more devices.

20. The method of claim 11, wherein generating a request to reduce the beacon load comprises generating the request to reduce the beacon load to include at least one of a detected beacon load, a beacon load per basic service set identification, or a suggested beacon load reduction criterion.

21. A wireless node for wireless communication, comprising:
an antenna;
a processing system, configured to:
process a beacon load of the wireless node, a beacon load comprising at least one beacon received via the antenna;
determine if the beacon load satisfies a criterion; and
generate a request to reduce a beacon load if the beacon load satisfies the criterion.

22. A computer program product comprising a computer readable storage device encoded thereon with instructions that when executed cause an apparatus to perform a method of wireless communication, said method comprising:
receiving a beacon load from one or more devices;
determining if the received beacon load from the one or more devices satisfies a criterion;
generating a request to reduce the beacon load if the received beacon load does not satisfy the criterion; and
transmitting the request to reduce the beacon load to the one or more devices.
